(19) United States
(12) Patent Application Publication
(10) Pub. No.: US 2024/0330793 A1
(43) Pub. Date: Oct. 3, 2024

(54) AIRCRAFT MANAGEMENT SYSTEM AND AIRCRAFT MANAGEMENT METHOD

(71) Applicant: HONDA MOTOR CO., LTD., Tokyo (JP)

(72) Inventor: Katsumasa Ishikawa, Wako-shi (JP)

(21) Appl. No.: 18/594,652

(22) Filed: Mar. 4, 2024

(30) Foreign Application Priority Data
Mar. 28, 2023 (JP) 2023-052064

(51) Int. Cl. G06Q 10/0631; G01C 21/34; G06Q 30/0207; G06Q 50/47

(52) U.S. Cl. CPC G06Q 10/06311; G01C 21/3423; G01C 21/3438; G06Q 30/0207; G06Q 50/47

(57) ABSTRACT

An aircraft management system includes: a suitable user extraction section that extracts a suitable user, based on user schedule information on a plurality of users and aircraft flight plan information, the suitable user being a user having a traveling schedule to which traveling via a common specific air route on a common specific date and time is applicable; and a flight use suggestion section that, when a first predetermined number of the suitable users or more are extracted, transmits specific flight use suggestion information to a communication terminal used by each of the suitable users, the specific flight use suggestion information suggesting use of a specific flight corresponding to the traveling via the specific air route on the specific date and time.

### INCORPORATION BY REFERENCE

The present application claims priority under 35 U.S.C. § 119 to Japanese Patent Application No. 2023-052064 filed on Mar. 28, 2023. The content of the application is incorporated herein by reference in its entirety.

### BACKGROUND OF THE INVENTION

### Field of the Invention

The present invention relates to an aircraft management system and an aircraft management method.

### Description of the Related Art

Conventionally, there has been disclosed a technique for creating a candidate itinerary in which traveling by air and traveling by land of a user are matched, by allowing a service provider that arranges traveling by aircraft and a service provider that arranges traveling by vehicle to work in liaison with each other (for example, see U.S. Pat. No. 10,837,786).

In flight of an aircraft, an efficient flight can be carried out by increasing passenger load factor. However, in the related art, since traveling by aircraft is arranged in response to a request from a user, it is not taken into consideration to increase the passenger load factor of an aircraft. Accordingly, there is room for improvement to carry out an efficient flight by increasing passenger load factor, particularly with regard to aircrafts with small passenger capacities, such as VTOL aircrafts (Vertical Take-Off and Landing aircrafts).

The present invention has been made in light of such background, and an object thereof is to provide an aircraft management system and an aircraft management method that can support an efficient flight of an aircraft by increasing passenger load factor.

### SUMMARY OF THE INVENTION

A first aspect to achieve the object is an aircraft management system including: a user schedule information acquisition section that acquires user schedule information on a plurality of users, the user schedule information indicating a traveling schedule of each user, the user schedule information being transmitted from a communication terminal used by each user; an aircraft flight plan information acquisition section that acquires aircraft flight plan information indicating a flight plan of an aircraft, by accessing an aircraft flight database in which the flight plan is recorded; a suitable user extraction section that extracts a suitable user, based on the user schedule information on the plurality of users and the aircraft flight plan information, the suitable user being the user having the traveling schedule to which traveling via a common specific air route on a common specific date and time is applicable; and a flight use suggestion section that, when a first predetermined number of the suitable users or more are extracted by the suitable user extraction section, transmits specific flight use suggestion information to the communication terminal used by each of the suitable users, the specific flight use suggestion information suggesting use of a specific flight corresponding to the traveling via the specific air route on the specific date and time.

The aircraft management system may be configured to further include: a specific flight use application reception section that accepts an application for use of the specific flight by the suitable user, by receiving specific flight use application information applying for use of the specific flight, the specific flight use application information being transmitted from the communication terminal used by the suitable user in response to reception of the specific flight use suggestion information; and a flight arrangement section that executes a specific flight arrangement process for conducting the specific flight when the number of the suitable users from which the applications for use of the specific flight are accepted by the specific flight use application reception section is a second predetermined number of people or more.

In the aircraft management system, the second predetermined number of people may be configured to be set to a number of people that makes passenger load factor of an aircraft used for the specific flight equal to a predetermined determination passenger load factor.

In the aircraft management system, the specific flight use suggestion information may be configured to include information related to an incentive to the suitable user, the incentive being able to be gained for use of the specific flight.

The aircraft management system may be configured to further include a ground transportation operation plan information acquisition section that acquires ground transportation operation plan information indicating an operation plan of a ground transportation, by accessing a ground transportation operation database in which the operation plan is recorded, wherein the suitable user extraction section may be configured to extract, as the suitable user, the user having the traveling schedule to which combinational traveling is applicable, based on the user schedule information on the plurality of users, the aircraft flight plan information, and the ground transportation operation plan information, the combinational traveling being a combination of the traveling via the common specific air route on the common specific date and time, and traveling by ground transportation over at least one of a first ground traveling route and a second ground traveling route, the first ground traveling route being a ground traveling route from a traveling starting point in the traveling schedule of the user up to a departure point of the specific air route, the second ground traveling route being a ground traveling route from an arrival point of the specific air route up to a traveling ending point in the traveling schedule of the user.

The aircraft management system may be configured to further include: a ground transportation use suggestion section that, when a common traveling section is recognized in the first ground traveling routes or the second ground traveling routes for a plurality of the suitable users, transmits shared ground transportation use suggestion information to the communication terminal used by each of the suitable users for which the traveling section is recognized, the shared ground transportation use suggestion information suggesting use of a ground transportation that travels over the traveling section in a shared manner.

A second aspect to achieve the object is an aircraft management method executed by a computer, including: a user schedule information acquisition step of acquiring user schedule information on a plurality of users, the user schedule information indicating a traveling schedule of each user, the user schedule information being transmitted from a communication terminal used by each user; an aircraft flight plan information acquisition step of acquiring aircraft flight plan information indicating a flight plan of an aircraft, by accessing an aircraft flight database in which the flight plan is recorded; a suitable user extraction step of extracting a suitable user, based on the user schedule information on the plurality of users and the aircraft flight plan information, the suitable user being the user having the traveling schedule to which traveling via a common specific air route on a common specific date and time is applicable; and a flight use suggestion step of, when a first predetermined number of the suitable users or more are extracted in the suitable user extraction step, transmitting specific flight use suggestion information to the communication terminal used by each of the suitable users, the specific flight use suggestion information suggesting use of a specific flight corresponding to the traveling via the specific air route on the specific date and time.

According to the aircraft management system and the aircraft management method, it is possible to support an efficient flight of an aircraft by increasing passenger load factor.

### BRIEF DESCRIPTION OF THE DRAWINGS

FIG. 1 is an explanatory diagram of an aspect in which a specific flight is arranged by an aircraft management system;

FIG. 2 is a configuration diagram of the aircraft management system;

FIG. 3 is an explanatory diagram of traveling schedules of individual users;

FIG. 4 is an explanatory diagram of examples of ground traveling routes and an air route applied to the traveling schedule of each user;

FIG. 5 is a first flowchart of a process of suggesting use of a specific flight; and

FIG. 6 is a second flowchart of the process of suggesting use of the specific flight.

### DETAILED DESCRIPTION OF THE PREFERRED EMBODIMENTS

### 1. Arrangement of Specific Flight by Aircraft Management System

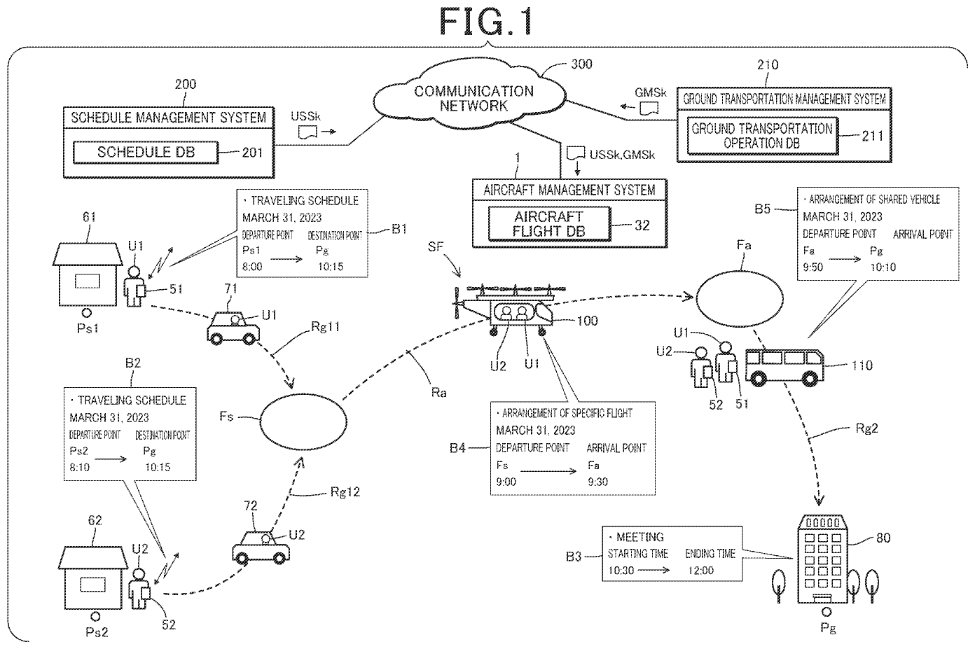

With reference to FIG. 1, an aspect is described in which a specific flight is arranged by an aircraft management system 1 according to a present embodiment. FIG. 1 shows an example in which a specific flight SF by sharing an aircraft 100 is arranged for a plurality of users U1, U2. The aircraft 100 is, for example, an eVTOL (electric Vertical Take-Off and Landing) aircraft.

The aircraft management system 1 communicates with a schedule management system 200, a ground transportation management system 210, a communication terminal 51 used by the user U1, a communication terminal 52 used by the user U2, and the like via a communication network 300. The communication terminals 51, 52 are terminal equipment having communication functionality, such as smartphones, mobile telephones, or tablet terminals. The aircraft management system 1 includes an aircraft flight DB (database) 32 in which flight plans of a plurality of aircrafts including the aircraft 100 are updated as needed and recorded. The flight plans of aircrafts include a regular flight schedule of an aircraft, availability of an aircraft that can be chartered on demand, and the like.

The schedule management system 200 receives schedule information on the users U1, U2 as needed via the communication network 300 and records in the schedule DB 201. The schedule information on the users U1, U2 is transmitted by a schedule management app executed on the communication terminals 51, 52, respectively. The schedule information includes a traveling schedule of the user U1, U2. The ground transportation management system 210 includes a ground transportation operation DB 211 in which operation status of ground transportations, such as passenger vehicles, railroads, and regular-route buses, is recorded as needed. The operation status of ground transportations includes a regular operation schedule, availability of an on-demand hire vehicle that is arranged in response to a request from a user, such as a rental car or a shared car, and the like.

The aircraft management system 1 acquires the schedule information USSk on the users U1, U2 by accessing the schedule DB 201, and recognizes the traveling schedules of the users U1, U2 from the schedule information USSk. In the example in FIG. 1, the traveling schedule of the user U1 is recognized as indicated in callout B1, in which on Mar. 31, 2023, the user U1 departs Ps1, which is the location point of home 61, at 8:00 and arrives at Pg, which is the location point of a facility 80 where a meeting to be attended by the user U1 takes place as indicated in callout B3, at 10:15, which is 15 minutes prior to a meeting starting time of 10:30.

Moreover, the traveling schedule of the user U2 is recognized as indicated in callout B2, in which on Mar. 31, 2023, the user U2 departs Ps2, which is the location point of home 62, at 8:10 and arrives at Pg, which is the location point of the facility 80 where the meeting to be attended by the user U2 takes place as indicated in callout B3, at 10:15, which is 15 minutes prior to the meeting starting time of 10:30.

The aircraft management system 1, by referring to the aircraft flight DB 32 and the ground transportation operation DB 211, searches for a flight that can be applied to the traveling schedules of the users U1, U2, with a required time period for traveling by land taken into account. In other words, a flight is searched for that enables traveling by air within a time frame excluding the required time period for traveling by land. The aircraft management system 1 extracts a flight that travels over a specific air route Ra from a port Fs to a port Fa between 9:00 and 9:30, as a specific flight SF that can be applied to the traveling schedules of the users U1, U2.

The aircraft management system 1 suggests use of the specific flight SF to the users U1, U2 and, in response to application for use from the users U1, U2, arranges that the users U1, U2 use the specific flight SF. As described above, by collecting traveling by air of the plurality of users U1, U2 and suggesting traveling by sharing the aircraft 100, it is possible to increase the passenger load factor of the aircraft 100 and thus to support conduct of an efficient flight.

Further, in the example in FIG. 1, since both the destination points of the users U1, U2 are Pg, the aircraft management system 1 executes a process of suggesting traveling over a second ground traveling route Rg2 from the port Fa up to Pg by using a shared vehicle 110. Thus, it is possible to also support efficient traveling over a ground traveling route.

### 2. Configuration of Aircraft Management System 1

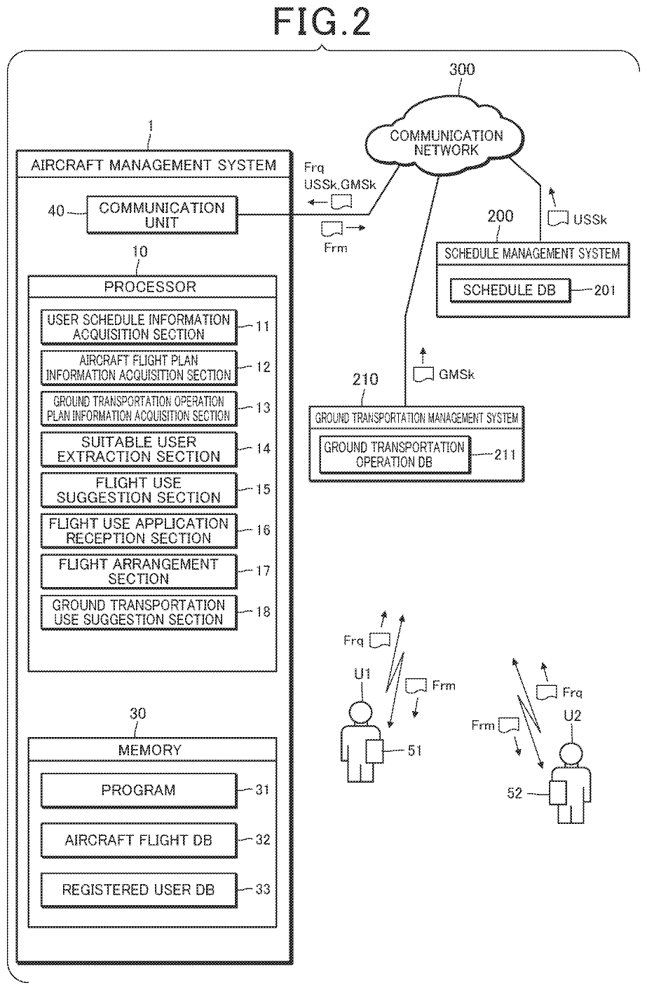

With reference to FIGS. 2 to 4, a configuration of the aircraft management system 1 is described. Referring to FIG. 2, the aircraft management system 1 is a computer system including a processor 10, a memory 30, a communication unit 40, and the like. The aircraft management system 1 performs communication via the communication network 300 as described above, by using the communication unit 40.

The memory 30 stores a program 31 for control of the aircraft management system 1, the above-mentioned aircraft flight DB 32, a registered user DB 33 in which information on a user (including the above-mentioned users U1, U2) who has registered to use a service provided by the aircraft management system 1 is recorded, and the like. The information on a user includes the address of a home, whether or not the user owns a vehicle, a transportation usually used by the user, and the like, with regard to each user.

By reading and executing the program 31, the processor 10 functions as a user schedule information acquisition section 11, an aircraft flight plan information acquisition section 12, a ground transportation operation plan information acquisition section 13, a suitable user extraction section 14, a flight use suggestion section 15, a flight use application reception section 16, a flight arrangement section 17, and a ground transportation use suggestion section 18.

A process executed by the user schedule information acquisition section 11 corresponds to “user schedule information acquisition step” in the aircraft management method of the present disclosure, and a process executed by the aircraft flight plan information acquisition section 12 corresponds to “aircraft flight plan information acquisition step” in the aircraft management method of the present disclosure. A process executed by the suitable user extraction section 14 corresponds to “suitable user extraction step” in the aircraft management method of the present disclosure, and a process executed by the flight use suggestion section 15 corresponds to “flight use suggestion step” in the aircraft management method of the present disclosure.

The user schedule information acquisition section 11 accesses the schedule DB 201 of the schedule management system 200 and acquires schedule information USSk on each user registered with the aircraft management system 1. The aircraft flight plan information acquisition section 12 refers to the aircraft flight DB 32 and acquires flight plan information on each aircraft managed by the aircraft management system 1.

The ground transportation operation plan information acquisition section 13 accesses the ground transportation operation DB 211 of the ground transportation management system 210 and acquires operation plan information GMSk on a ground transportation. The suitable user extraction section 14 extracts a suitable user that is a user to which traveling via a common air route on a common date and time can be applied.

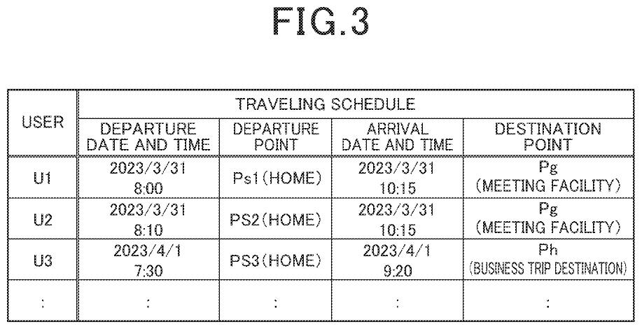

The suitable user extraction section 14 refers to the schedule information USSk on each user and recognizes a traveling schedule of each user as shown in FIG. 3. Users U1, U2 in FIG. 3 correspond to the users U1, U2 shown in FIGS. 1, 2. The suitable user extraction section 14 then refers to the aircraft flight plan information acquired by the aircraft flight plan information acquisition section 12 and the ground transportation operation plan information acquired by the ground transportation operation plan information acquisition section 13, and extracts, as a suitable user, a user to which traveling via a common specific air route on a common specific date can be applied.

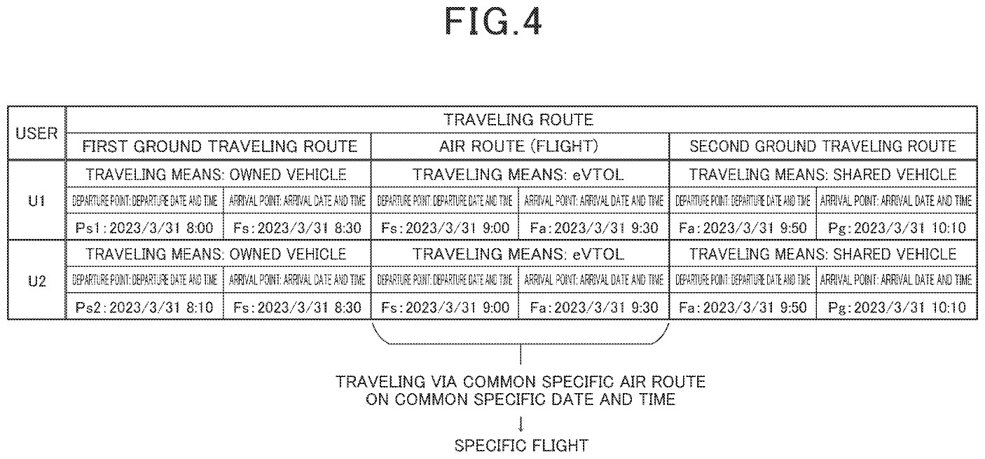

FIG. 4 illustrates a case in which, as suitable users, the users U1, U2 are extracted to which traveling via a common air route (Fs→Fa) on a common date and time (from 9:00 until 9:30 on Mar. 31, 2023) can be applied. In such a case, the suitable user extraction section 14 recognizes that the user U1 can travel by using an owned vehicle 71 over a first ground traveling route Rg11 from the location point of home Ps1, which is the starting point of traveling of the user U1, up to the port Fs, and can use the shared vehicle 110 over the second ground traveling route Rg2 from the port Fa up to Pg, which is the destination point of the user U1, as shown in FIG. 1.

Accordingly, with regard to the user U1, the suitable user extraction section 14 determines that it is possible to apply the traveling via the specific air route Ra that, in combination with the traveling over the first ground traveling route Rg11 by using the owned vehicle 71 and the traveling over the second ground traveling route Rg2 by using the shared vehicle 110, can ensure the arrival time of 10:15 at the destination point Pg according to the traveling schedule of the user U1, and therefore extracts the user U1 as a suitable user.

Moreover, with regard to the user U2, the suitable user extraction section 14 determines that it is possible to apply the traveling via the specific air route Ra that, in combination with traveling over a first ground traveling route Rg12 by using an owned vehicle 72 and the traveling over the second ground traveling route Rg2 by using the shared vehicle 110, can ensure the arrival time of 10:15 at the destination point Pg according to the traveling schedule of the user U2, and therefore extracts the user U2 as a suitable user.

When the number of suitable users extracted by the suitable user extraction section 14 is a first predetermined number of people or more, the flight use suggestion section 15 transmits, to a communication terminal used by each suitable user, specific flight use suggestion information Frm suggesting use of a specific flight corresponding to the traveling via the specific air route on the specific date and time. Here, the first predetermined number of people is set to, for example, a number of people that makes passenger load factor equal to or more than a determination passenger load factor (for example, 50%), depending on the number of users that can be aboard an aircraft used for the specific flight. FIG. 2 shows an example in which the specific flight use suggestion information Frm suggesting use of the specific flight SF (see FIG. 1) is transmitted from the aircraft management system 1 to the communication terminals 51, 52 of the users U1, U2 who are extracted as suitable users.

The specific flight use suggestion information Frm may include information on a ground transportation that the suitable user can use, when using the specific flight, to travel over a ground traveling route up to a departure point of the specific flight or to travel over a ground traveling route from an arrival point of the specific flight. The specific flight use suggestion information Frm may include information on an incentive (a discount off the charge for use, giving of a coupon, giving of a shopping point, or the like) that can be gained for use of the specific flight.

The flight use application reception section 16 receives specific flight use application information applying for use of the specific flight from the communication terminal of a suitable user who has received the specific flight use suggestion information Frm, and thereby accepts an application for use of the specific flight by the suitable user. FIG. 2 shows an example in which the specific flight use application information Frq is transmitted to the aircraft management system 1 from the communication terminals 51, 52 of the users U1, U2 who are extracted as suitable users.

When the number of suitable users from which the applications for use of the specific flight are accepted becomes a second predetermined number of people or more, the flight arrangement section 17 executes a process for conducting the specific flight. Here, the second predetermined number of people is set to, for example, a number of people that makes passenger load factor equal to or more than a determination passenger load factor (for example, 50%), depending on the number of users that can be aboard an aircraft used for the specific flight. The second predetermined number is set to be equal to or smaller than the first predetermined number. The flight arrangement section 17 executes a process of reserving seats when the specific flight is a regular flight, and, when the specific flight is a chartered flight, executes a process of securing an aircraft used to conduct the chartered flight.

The ground transportation use suggestion section 18 transmits, to the communication terminal of each suitable user, information on a ground transportation that can be applied to use in combination with the specific flight. In the example in FIG. 1, information on the shared vehicle 110 that can be used by the users U1, U to travel from the port Fa up to the destination point Pg is transmitted from the aircraft management system 1 to the communication terminals 51, 52 of the users U1, U2.

In the example in FIG. 1, since both the destinations of traveling of the user U1 and the user U2 are Pg, the ground transportation use suggestion section 18 transmits the information on the shared vehicle 110 to the communication terminals 51, 52 of the users U1, U2. In contrast, when the destinations of the user U1 and the user U2 are different, the ground transportation use suggestion section 18 transmits information on a ground transportation that can be applied for traveling from the port Fa up to the destination of the user U1 to the communication terminal 51 of the user U1, and transmits information on a ground transportation that can be applied for traveling from the port Fa up to the destination of the user U2 to the communication terminal 52 of the user U2.

### 3. Process of Suggesting Use of Specific Flight

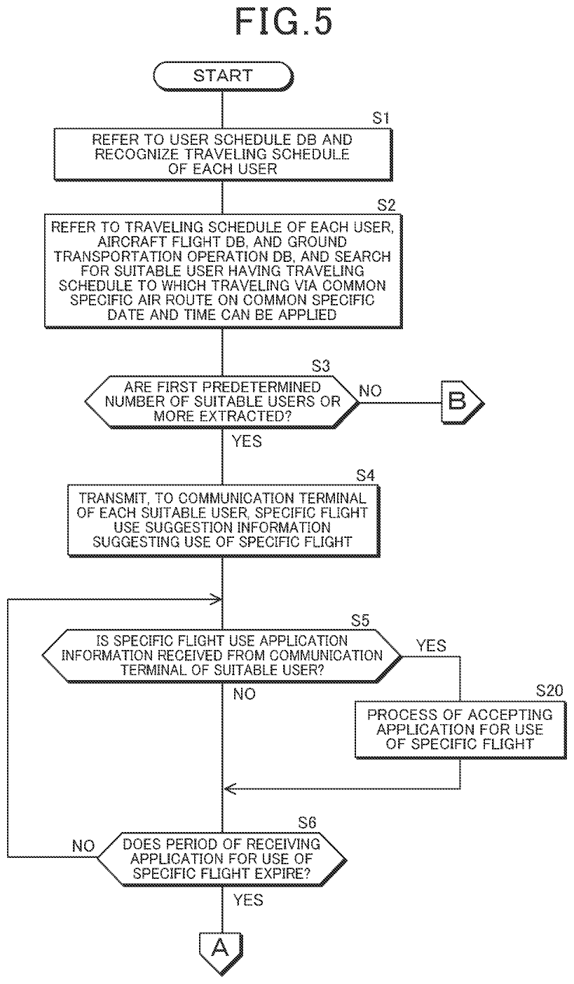

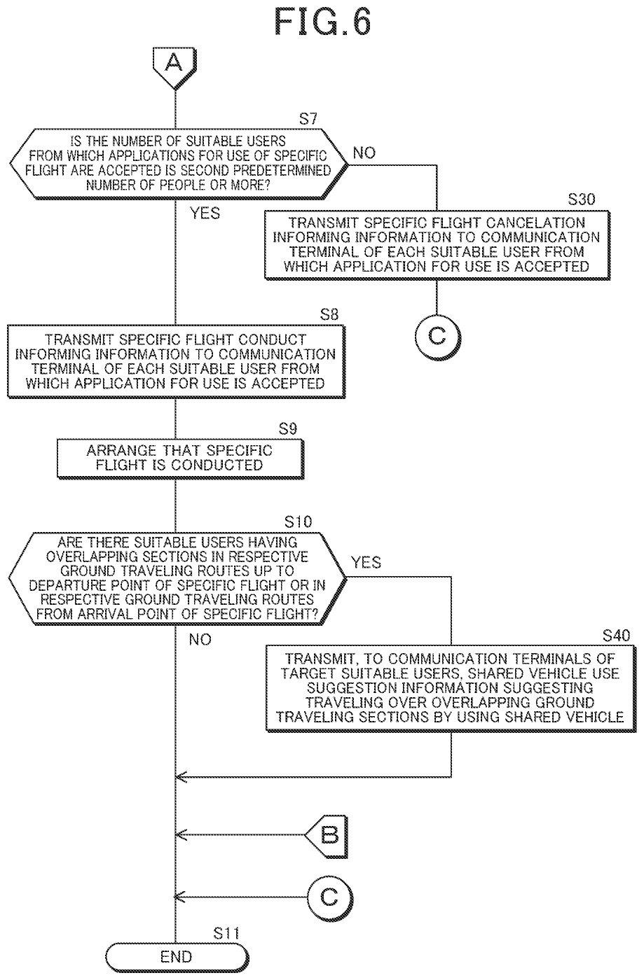

A process of suggesting use of a specific flight, which is executed by the aircraft management system 1, is described by following flowcharts shown in FIGS. 5 to 6. The aircraft management system 1 executes the process according to the flowcharts in FIGS. 5 to 6 in each predetermined control cycle, or on an occasion such as when a situation arises in which rising demand for a specific air route is expected due to an event taking place or the like.

In step S1 in FIG. 5, the suitable user extraction section 14 refers to the schedule information USSk on each user acquired by the user schedule information acquisition section 11 and recognizes the traveling schedule of each user as shown in FIG. 3. In subsequent step S2, the suitable user extraction section 14 extracts suitable users having the traveling schedules to which traveling via a common specific air route on a common specific date and time can be applied as illustrated in FIG. 4, based on the traveling schedule of each user, the aircraft flight plan information acquired by the aircraft flight plan information acquisition section 12, and the ground transportation operation plan information acquired by the ground transportation operation plan information acquisition section 13.

Here, when a suitable user is extracted who has the traveling schedule to which different conditions of traveling via a plurality of different specific air routes on a plurality of different specific dates and times can be applied, the aircraft management system 1 executes processes in and after step S3, individually for each group of suitable users extracted with regard to each condition of traveling.

In next step S3, the suitable user extraction section 14 determines whether or not the first predetermined number of suitable users or more are extracted. The suitable user extraction section 14 moves the process to step S4 when the first predetermined number of suitable users or more are extracted. When the first predetermined number of suitable users or more are not extracted, the process is moved to step S11 in FIG. 6, and the process in a current control cycle is terminated.

In step S4, the flight use suggestion section 15 transmits, to the communication terminal of each suitable user, specific flight use suggestion information Frm suggesting use of a specific flight corresponding to the traveling via the specific air route on the specific date and time. The specific flight use suggestion information Frm may include information on a ground transportation available for traveling by land before or after, or before and after, the specific flight. In the examples shown in FIGS. 1, 2, the specific flight use suggestion information Frm is transmitted to the communication terminals 51, 52 of the users U1, U2, and the specific flight use suggestion information Frm includes information on the shared vehicle 110.

Through processes in subsequent steps S5, S6, the flight use application reception section 16 repeatedly executes a process in step S5 of determining whether or not specific flight use application information Frq is received from the communication terminal of a suitable user, until a period of accepting an application for use of the specific flight (which is set, for example, a few days or the like before the date and time of conducting the specific flight) expires in step S6. When the specific flight use application information Frq is received in step S5, the flight use application reception section 16 moves the process to step S20, accepts the application for use of the specific flight by the suitable user, and then moves the process to step S6.

When the period of accepting an application for use of the specific flight expires in step S6, the flight use application reception section 16 moves the process to step S7 in FIG. 6. In step S7 in FIG. 6, the flight arrangement section 17 determines whether or not the number of suitable users from which the applications for use of the specific flight are accepted is the second predetermined number of people or more. The second predetermined number is set to be equal to or smaller than the first predetermined number.

The flight arrangement section 17 moves the process to step S8 when the number of suitable users from which the applications for use of the specific flight are accepted is the second predetermined number of people or more, and moves the process to step S30 when the number of suitable users from which the applications for use of the specific flight are accepted is smaller than the second predetermined number.

In step S30, the flight arrangement section 17 transmits specific flight cancelation informing information to the communication terminal of each suitable user from which the application for use of the specific flight is accepted, and then moves the process to step S11. Thus, the specific flight avoids being conducted in a state of poor transportation efficiency with a low passenger load factor.

In step S8, the flight arrangement section 17 notifies that it is determined to conduct the specific flight, by transmitting specific flight conduct informing information to the communication terminal of each suitable user from which the application for use of the specific flight is accepted. In subsequent step S9, the flight arrangement section 17 arranges that the specific flight is conducted. In the example in FIG. 1, conduct of the specific flight SF to be used by the users U1, U2 is arranged.

In next step S10, the ground transportation use suggestion section 18 determines whether or not there are suitable users who have overlapping traveling sections in the respective first ground routes up to the departure point of the specific flight, or in the respective second ground routes from the arrival point of the specific flight. The ground transportation use suggestion section 18 moves the process to step S40 when there are suitable users who have overlapping traveling sections, and moves the process to step S11 when there are no suitable users who have overlapping traveling sections.

In step S40, the ground transportation use suggestion section 18 transmits, to the communication terminal of each suitable user having the overlapping traveling section, shared vehicle use suggestion information suggesting traveling over the overlapping traveling section by using a shared vehicle, and then moves the process to step S11. Thus, also with regard to ground traveling, it is possible to support efficient traveling.

### 4. Other Embodiments

In the embodiment, the ground transportation operation plan information acquisition section 13 is included, and the suitable user extraction section 14 extracts suitable users to which traveling via a common air route on a common specific date and time can be applied, with a time period required for traveling by ground transportation taken into account. As another embodiment, the ground transportation operation plan information acquisition section 13 may be omitted, and suitable users to which traveling via a common air route on a common specific date and time can be applied may be extracted, by using, for a time period of ground traveling, an assumed required time period or the like that is set in advance according to a traveling distance.

In the embodiment, the ground transportation use suggestion section 18 is included, and the process of suggesting traveling by shared vehicle to suitable users having overlapping sections in the respective ground traveling routes. However, a configuration may be made in which the ground transportation use suggestion section 18 is omitted.

In the embodiment, the aircraft management system 1 arranges a specific flight corresponding to traveling via a common specific air route on a common specific date and time, for a plurality of users of which the traveling schedules are recognized from the schedule information. However, there are some cases where a user exists who has booked the specific flight through another management system (a booking system of a travel agency, or the like). Accordingly, assuming such a case, handling may be performed as follows.

In step S3 in FIG. 5, it is determined whether or not the total number of suitable users extracted by search in step S2 and a user or users who have booked the specific flight through another management system is the first predetermined number of people or more.

In step S7 in FIG. 6, it is determined whether or not the total number of the suitable users from which the applications for use of the specific flight are accepted and the user or users who have booked the specific flight through the other management system is the second predetermined number of people or more.

In step S30 in FIG. 6, when the booking of the specific flight is fixed for the user or users who have booked the specific flight through the other management system, the specific flight is arranged for the suitable users from which the applications for use are accepted, without transmitting the specific flight cancelation informing information.

In step S30 in FIG. 6, when a requirement that the number of users who fix the booking of the specific flight should be the second predetermined number of people or more is imposed as a condition of conducting the specific flight on the user or users who have booked the specific flight through the other management system, the user or users who have booked the specific flight through the other management system are also informed of cancelation of the specific flight.

Note that FIG. 2 is a schematic diagram showing the functional components of the aircraft management system 1 as a result of segmentation based on the main processes in order to facilitate the understanding of the invention of the present application, and the configuration of the aircraft management system 1 may be segmented based on other categories. A process by each constituent element may be executed by a single hardware unit, or may be executed by a plurality of hardware units. The processes by the individual constituted elements shown in FIGS. 5 and 6 may be executed by using a single program, or may be executed by using a plurality of programs.

### 5. Configurations Supported by the Embodiment

The embodiment is a specific example of configurations described below.

(Configuration 1) An aircraft management system including: a user schedule information acquisition section that acquires user schedule information on a plurality of users, the user schedule information indicating a traveling schedule of each user, the user schedule information being transmitted from a communication terminal used by each user; an aircraft flight plan information acquisition section that acquires aircraft flight plan information indicating a flight plan of an aircraft, by accessing an aircraft flight database in which the flight plan is recorded; a suitable user extraction section that extracts a suitable user, based on the user schedule information on the plurality of users and the aircraft flight plan information, the suitable user being the user having the traveling schedule to which traveling via a common specific air route on a common specific date and time is applicable; and a flight use suggestion section that, when a first predetermined number of the suitable users or more are extracted by the suitable user extraction section, transmits specific flight use suggestion information to the communication terminal used by each of the suitable users, the specific flight use suggestion information suggesting use of a specific flight corresponding to the traveling via the specific air route on the specific date and time.

According to the aircraft management system in configuration 1, by extracting a suitable user having a traveling schedule to which traveling via a common specific air route on a common specific date and time can be applied, and by suggesting use of a specific flight corresponding to the traveling via the specific air route on the specific date and time, it is possible to increase passenger load factor and thus to support an efficient flight of an aircraft.

(Configuration 2) The aircraft management system according to configuration 1, further including: a specific flight use application reception section that accepts an application for use of the specific flight by the suitable user, by receiving specific flight use application information applying for use of the specific flight, the specific flight use application information being transmitted from the communication terminal used by the suitable user in response to reception of the specific flight use suggestion information; and a flight arrangement section that executes a specific flight arrangement process for conducting the specific flight when the number of the suitable users from which the applications for use of the specific flight are accepted by the specific flight use application reception section is a second predetermined number of people or more.

According to the aircraft management system in configuration 2, it is possible to arrange that the specific flight is conducted when the number of the suitable users who apply for use of the specific flight is the second predetermined number of people or more and passengers of the specific flight are therefore secured to a certain degree.

(Configuration 3) The aircraft management system according to configuration 2, wherein the second predetermined number of people is set to a number of people that makes passenger load factor of an aircraft used for the specific flight equal to a predetermined determination passenger load factor.

According to the aircraft management system in configuration 3, it is possible to arrange that the specific flight is conducted when a certain degree or more of passenger load factor is ensured for the specific flight.

(Configuration 4) The aircraft management system according to any one of configurations 1 to 3, wherein the specific flight use suggestion information includes information related to an incentive to the suitable user, the incentive being able to be gained for use of the specific flight.

According to the aircraft management system in configuration 4, by providing the information related to the incentive, it is possible to encourage the suitable user to use the specific flight.

(Configuration 5) The aircraft management system according to any one of configurations 1 to 4, further including a ground transportation operation plan information acquisition section that acquires ground transportation operation plan information indicating an operation plan of a ground transportation, by accessing a ground transportation operation database in which the operation plan is recorded, wherein the suitable user extraction section extracts, as the suitable user, the user having the traveling schedule to which combinational traveling is applicable, based on the user schedule information on the plurality of users, the aircraft flight plan information, and the ground transportation operation plan information, the combinational traveling being a combination of the traveling via the common specific air route on the common specific date and time, and traveling by ground transportation over at least one of a first ground traveling route and a second ground traveling route, the first ground traveling route being a ground traveling route from a traveling starting point in the traveling schedule of the user up to a departure point of the specific air route, the second ground traveling route being a ground traveling route from an arrival point of the specific air route up to a traveling ending point in the traveling schedule of the user.

According to the aircraft management system in configuration 5, it is possible to extract, as the suitable user, a user having a traveling schedule to which a condition of total traveling, including traveling over a ground traveling route by ground transportation when the specific flight is used, can be applied.

(Configuration 6) The aircraft management system according to configuration 5, further comprising a ground transportation use suggestion section that, when a common traveling section is recognized in the first ground traveling routes or the second ground traveling routes for a plurality of the suitable users, transmits shared ground transportation use suggestion information to the communication terminal used by each of the suitable users for which the traveling section is recognized, the shared ground transportation use suggestion information suggesting use of a ground transportation that travels over the traveling section in a shared manner.

According to the aircraft management system in configuration 6, by suggesting use of the ground transportation that travels in a shared manner to the plurality of suitable users who travel over the common ground traveling section when the specific flight is used, it is possible to support efficient ground traveling.

(Configuration 7) An aircraft management method executed by a computer, including: a user schedule information acquisition step of acquiring user schedule information on a plurality of users, the user schedule information indicating a traveling schedule of each user, the user schedule information being transmitted from a communication terminal used by each user; an aircraft flight plan information acquisition step of acquiring aircraft flight plan information indicating a flight plan of an aircraft, by accessing an aircraft flight database in which the flight plan is recorded; a suitable user extraction step of extracting a suitable user, based on the user schedule information on the plurality of users and the aircraft flight plan information, the suitable user being the user having the traveling schedule to which traveling via a common specific air route on a common specific date and time is applicable; and a flight use suggestion step of, when a first predetermined number of the suitable users or more are extracted in the suitable user extraction step, transmitting specific flight use suggestion information to the communication terminal used by each of the suitable users, the specific flight use suggestion information suggesting use of a specific flight corresponding to the traveling via the specific air route on the specific date and time.

By causing a computer to execute the aircraft management method in configuration 7, operations and effects similar to those of the aircraft management system in configuration 1 can be brought about.

### REFERENCE SIGNS LIST

1 aircraft management system, 10 processor, 11 user schedule information acquisition section, 12 aircraft flight plan information acquisition section, 13 ground transportation operation plan information acquisition section, 14 suitable user extraction section, 15 flight use suggestion section, 16 flight use application reception section, 17 flight arrangement section, 18 ground transportation use suggestion section, 30 memory, 31 program, 32 aircraft flight DB, 33 registered user DB, 40 communication unit, 50, 51 communication terminal, 71, 72 owned vehicle, 100 aircraft, 110 shared vehicle, 200 schedule management system, 201 schedule DB, 210 ground transportation management system, 211 ground transportation operation DB, 300 communication network, U1, U2 user, suitable user

What is claimed is:

1. An aircraft management system comprising:
a user schedule information acquisition section that acquires user schedule information on a plurality of users, the user schedule information indicating a traveling schedule of each user, the user schedule information being transmitted from a communication terminal used by each user;
an aircraft flight plan information acquisition section that acquires aircraft flight plan information indicating a flight plan of an aircraft, by accessing an aircraft flight database in which the flight plan is recorded;
a suitable user extraction section that extracts a suitable user, based on the user schedule information on the plurality of users and the aircraft flight plan information, the suitable user being the user having the traveling schedule to which traveling via a common specific air route on a common specific date and time is applicable; and
a flight use suggestion section that, when a first predetermined number of the suitable users or more are extracted by the suitable user extraction section, transmits specific flight use suggestion information to the communication terminal used by each of the suitable users, the specific flight use suggestion information suggesting use of a specific flight corresponding to the traveling via the specific air route on the specific date and time.

2. The aircraft management system according to claim 1, further comprising:
a specific flight use application reception section that accepts an application for use of the specific flight by the suitable user, by receiving specific flight use application information applying for use of the specific flight, the specific flight use application information being transmitted from the communication terminal used by the suitable user in response to reception of the specific flight use suggestion information; and
a flight arrangement section that executes a specific flight arrangement process for conducting the specific flight when the number of the suitable users from which the applications for use of the specific flight are accepted by the specific flight use application reception section is a second predetermined number of people or more.

3. The aircraft management system according to claim 2, wherein the second predetermined number of people is set to a number of people that makes passenger load factor of an aircraft used for the specific flight equal to a predetermined determination passenger load factor.

4. The aircraft management system according to claim 1, wherein the specific flight use suggestion information includes information related to an incentive to the suitable user, the incentive being able to be gained for use of the specific flight.

5. The aircraft management system according to claim 1, further comprising a ground transportation operation plan information acquisition section that acquires ground transportation operation plan information indicating an operation plan of a ground transportation, by accessing a ground transportation operation database in which the operation plan is recorded,
wherein the suitable user extraction section extracts, as the suitable user, the user having the traveling schedule to which combinational traveling is applicable, based on the user schedule information on the plurality of users, the aircraft flight plan information, and the ground transportation operation plan information, the combinational traveling being a combination of the traveling via the common specific air route on the common specific date and time, and traveling by ground transportation over at least one of a first ground traveling route and a second ground traveling route, the first ground traveling route being a ground traveling route from a traveling starting point in the traveling schedule of the user up to a departure point of the specific air route, the second ground traveling route being a ground traveling route from an arrival point of the specific air route up to a traveling ending point in the traveling schedule of the user.

6. The aircraft management system according to claim 5, further comprising a ground transportation use suggestion section that, when a common traveling section is recognized in the first ground traveling routes or the second ground traveling routes for a plurality of the suitable users, transmits shared ground transportation use suggestion information to the communication terminal used by each of the suitable users for which the traveling section is recognized, the shared ground transportation use suggestion information suggesting use of a ground transportation that travels over the traveling section in a shared manner.

7. An aircraft management method executed by a computer, comprising:
a user schedule information acquisition step of acquiring user schedule information on a plurality of users, the user schedule information indicating a traveling schedule of each user, the user schedule information being transmitted from a communication terminal used by each user;
an aircraft flight plan information acquisition step of acquiring aircraft flight plan information indicating a flight plan of an aircraft, by accessing an aircraft flight database in which the flight plan is recorded;
a suitable user extraction step of extracting a suitable user, based on the user schedule information on the plurality of users and the aircraft flight plan information, the suitable user being the user having the traveling schedule to which traveling via a common specific air route on a common specific date and time is applicable; and
a flight use suggestion step of, when a first predetermined number of the suitable users or more are extracted in the suitable user extraction step, transmitting specific flight use suggestion information to the communication terminal used by each of the suitable users, the specific flight use suggestion information suggesting use of a specific flight corresponding to the traveling via the specific air route on the specific date and time.
